(19) United States
(12) Patent Application Publication
(10) Pub. No.: US 2007/0074165 A1
(43) Pub. Date: Mar. 29, 2007

(54) EXTENDED MULTI-LIFECYCLE BREAKDOWN STRUCTURE MODELS

(75) Inventors: J. Todd Fredrickson, Rockledge, FL (US); Peter Haumer, San Jose, CA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/381,067

(22) Filed: May 1, 2006

Related U.S. Application Data
(63) Continuation-in-part of application No. 11/238,550, filed on Sep. 29, 2005.

(51) Int. Cl. G06F 9/44

(52) U.S. Cl. 717/120; 717/104

(57) ABSTRACT

Embodiments of the present invention address deficiencies of the art in respect to method and process management, and provide a data processing system, method, and computer program product for providing extended multi-lifecycle breakdown structure models. In an embodiment of the invention, a methods management data processing system can be provided. The system can include a method management tool including program code enabled to render multiple views of different instances of different lifecycle models for a process described by a single breakdown centric process representation. For instance, the lifecycle models can include an incremental lifecycle model, a waterfall lifecycle model, an iterative lifecycle model and an evolutionary lifecycle model, to name only a few.

### CROSS-REFERENCE TO RELATED APPLICATIONS

This patent application claims the benefit under 35 U.S.C. § 120 as a continuation-in-part of presently pending U.S. patent application Ser. No. 11/238,550, entitled UNIFIED METHOD ARCHITECTURE, filed on Sep. 29, 2005, the entire teachings of which are incorporated herein by reference.

### BACKGROUND OF THE INVENTION

1. Field of the Invention

The present invention relates to the field of conceptual frameworks and tool support for the management of methods and processes, and more particularly to the systematic management of libraries of related method content and processes.

2. Description of the Related Art

A method architecture describes a schema for organizing large amounts of descriptions for development methods and processes, such as software engineering, mechanical engineering, business transformation, sales cycles and the like. A development method provides step-by-step explanations for a particular way of achieving a specific development goal under general circumstances such as transforming a requirements document into an analysis model, defining an architectural mechanism based on functional and non-functional requirements, creating a project plan for a development iteration, defining a quality assurance plan for functional requirements, or redesigning a business organization based on a new strategic direction.

A development process takes several of these methods and combines method steps into semi-ordered sequences creating a structure that is specific to temporal development circumstances such as how work is to be organized over time or the order of work based on events and decisions as may be represented by a workflow rather than strict sequential ordering. The structure also can be specific to one type of development project, for instance the characteristics of the development project including development software for an online system versus software and hardware for an embedded system. A process is defined based on a lifecycle, which specifies how method elements such as tasks are being applied and work products are being produced over time by particular roles within the process.

Presently, there are several method architecture frameworks available in industry for the documentation of methods and the specification of processes. Commercial method and process management products include the Rational Unified Process Workbench manufactured by IBM Corporation of Armonk, N.Y., United States. International standards for schemas for method and process management systems also exist. The most widely know standard of this field is the Software Process Engineering Meta-Model (SPEM) version 1.1 released by the Object Management Group (OMG). These frameworks have been widely deployed for use in the enterprise. Yet, each has a different architecture and usage. Moreover, none are compatible with one another.

A development process can be modeled according to one of several different lifecycle models. In this regard, traditional lifecycle models include the waterfall model, the iterative model, the incremental model and the evolutionary model, to name just a few. Ordinarily, a method architecture framework supports just one of the models according to preference. In some cases, method architecture frameworks support a hybridization of different lifecycle models. Where a method architecture framework supports a hybridization of different lifecycle models, the framework generally only can support a hybrid process rather than allow a native representation of the parent processes. Consequently, in each circumstance, the development process representation must be tied to the selected lifecycle model such that different process representations must be developed for each different lifecycle model.

### BRIEF SUMMARY OF THE INVENTION

Embodiments of the present invention address deficiencies of the art in respect to method and process management, and provide a novel and non-obvious data processing system, method, and computer program product for providing extended multi-lifecycle breakdown structure models. In an embodiment of the invention, a methods management data processing system can be provided. The system can include a method management tool including program code enabled to manage and render multiple instances of different lifecycle models as processes each described by a single breakdown centric process representation. For instance, the lifecycle models can include an incremental lifecycle model, a waterfall lifecycle model, an iterative lifecycle model and an evolutionary lifecycle model, to name only a few.

In another embodiment of the invention, a method for providing multiple instances of different lifecycle models as processes each described by a single breakdown centric process representation can be provided. The method can include defining a single breakdown structure architecture for one or more processes, and rendering different instances of different lifecycle models using the single breakdown structure architecture for the processes. In one aspect of the embodiment, rendering different instances of different lifecycle models using a single breakdown structure architecture for the processes can include rendering using the single breakdown structure architecture different lifecycles including an iterative lifecycle model view, a waterfall lifecycle model view, an incremental lifecycle model view, and an evolutionary lifecycle model view.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a methods management system configured for managing processes represented according to multiple, different lifecycle models using a single method architecture;

FIG. 2 is a class diagram of a portion of a process breakdown structure architecture arranged to support managing processes represented according to multiple, different lifecycle models in a method architecture; and,

FIG. 3 is a pictorial illustration of a process breakdown structure for producing multiple different lifecycle models for a single process in the methods management system of FIG. 1.

### DETAILED DESCRIPTION OF THE INVENTION

Embodiments of the present invention provide a method, data processing system and computer program product for supporting multiple, different lifecycle model views of a lifecycle independent, breakdown centric process representation. As used herein, a breakdown structure is a representation for a development process. The architecture of the breakdown structure permits the assembly and presentation of different lifecycle models for a process, whether in an iterative model, waterfall model, incremental model, or an evolutionary model, to name only a few. Consequently, changes in any of breakdown elements utilized in supporting one lifecycle model automatically can be reflected in the other lifecycle models without requiring the coordinated maintenance of separate structures corresponding to the other lifecycle models.

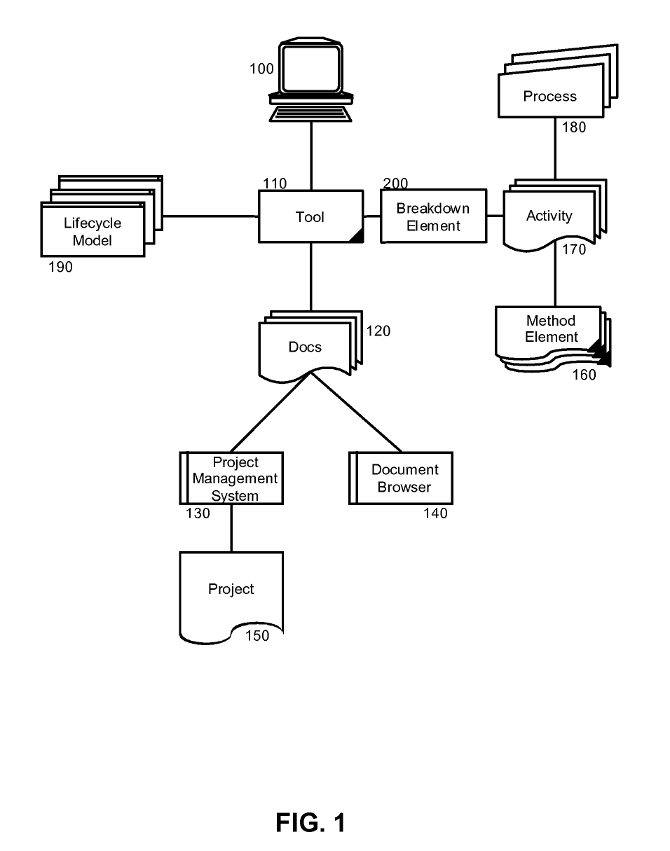

In more particular illustration, FIG. 1 is a schematic illustration of a methods management system configured for viewing a process in multiple, different lifecycle models in a method architecture. Referring to FIG. 1, a computing platform 100 can host a methods management tool 110 configured to arrange method elements 160 into activities 170 using descriptors for one or more processes 180 in a breakdown centric model. In this regard, the method elements 160 and activities and processes 180 can specialize a lifecycle independent data structure referred to as a breakdown element 200.

The breakdown element 200 can encapsulate core data including a description and usage guidance and can be linked to other breakdown elements 200 in a particular sequence in order to represent a process. The method elements 160 can specialize the breakdown elements 200 to define project methods and describe core elements of methods in terms of roles, tasks, work products and guidance. Finally, the activities and processes 180 can reference an arrangement of breakdown elements 200 to reflect an activity or process or an iteration.

Generally, the arrangement of method elements 160 can provide step-by-step explanations of how specific project goals can be achieved independently of the placement of the steps within a project lifecycle. As such, the methods management tool 110 can be configured to arrange the method elements 160 to produce one or more process documents 120. The process documents 120 can provide a description of a process and can be viewed within a document browser 140. Alternatively, the documents 120 can be provided as input to a project management system 130 to produce a project plan 150.

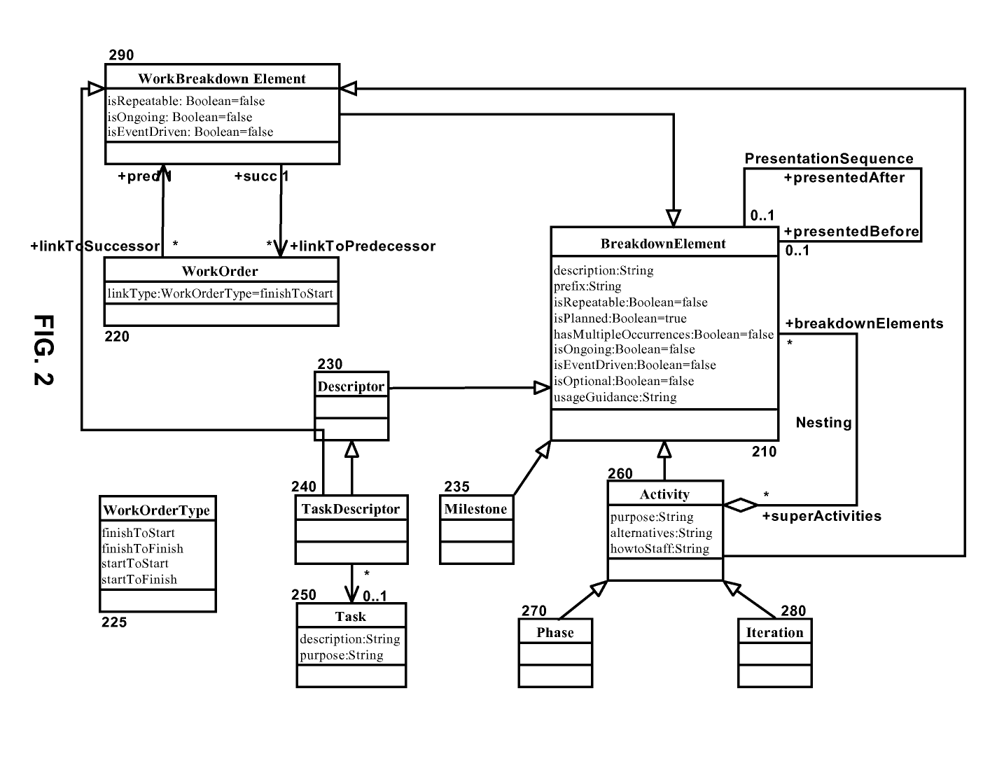

Importantly, a plurality of lifecycle models 190 for corresponding processes 180 can be supported by the method elements 160 for a single arrangement of breakdown elements 200. The lifecycle models 190 can include an iterative lifecycle model, a waterfall lifecycle model, an incremental lifecycle model, and an evolutionary lifecycle model, to list only a few examples. In further illustration, FIG. 2 is a class diagram of a portion of a process breakdown structure architecture arranged to support viewing a process in multiple, different lifecycle models in a method architecture. As shown in FIG. 2, a breakdown element 210 can form the core of the architecture enabling multiple different views of the same process.

Notably, as shown in FIG. 2, the breakdown element 210 can encapsulate several data members providing for flexibility in supporting multiple different lifecycle models. The data members include “is Repeatable”, “is Planned”, “hasMultipleOccurrences”, “is Ongoing”, “is EventDriven”, and “is Optional”. When combined with the association definitions “linkToPredecessor”, “linkToSuccessor”, “breakdownelements” and “superActivities”, the breakdown structure becomes generic in nature and can generically support the use of multiple, different lifecycle models, any one which can require the presence and use of one or more of the attributes and associations.

Each instance of the breakdown element 210 can reference other instances of the breakdown element 210 so as to form a sequence of breakdown elements as shown in FIG. 2. Activities 250 specialize breakdown elements further as do milestones 230, phases 270 and iterations 260. Notably, each instance of a breakdown element 210 can include an association with zero or more instances of an activity 250 in order to support a nested arrangement of activities and other breakdown elements in a process.

The breakdown element 210 can generalize a more specialized work breakdown element 290. The work breakdown element 290 can create and support linkages to both predecessor and successor instances of a work order 220 having a work order type 225 as shown in FIG. 2. The work order 220, itself can reflect a requested instance of a process that can include an arrangement of instances of an activity 260. The work breakdown element 290 also can generalize a task 250 via a task descriptor 240 which itself can generalize a descriptor 230.

A descriptor 230 can be characterized as a reference object for one particular method content element, which has its own relationships and properties. When an instance of a descriptor 230 is created it can be provided with congruent copies of the relationships defined for the referenced content element. However, these relationships can be modified for the particular process situation for which the instance of the descriptor 230 has been created. In this way, the use of a descriptor 230 allows each process to reference common method guidance from a common method content pool, which then makes up the actual process guidance. Because of these references, changes in the methods will automatically be reflected in all processes using descriptors 230.

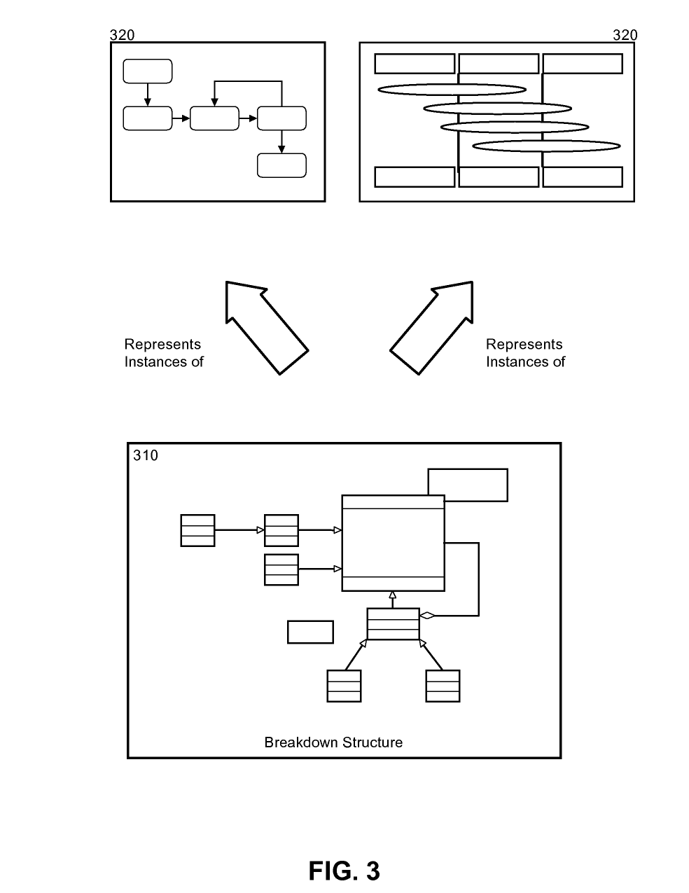

In consequence of the process breakdown architecture shown in FIG. 2, a view of a process formed through an arrangement of underlying instances of the breakdown structure 210 can support the production of a view of one or more different lifecycle models. In illustration, FIG. 3 is a pictorial illustration of a process breakdown structure for producing multiple different lifecycle models for a single process in the methods management system of FIG. 1. As shown in FIG. 3, a single breakdown structure 310, known to be lifecycle model independent, can support the production of multiple different views of instances of different lifecycle models 320, including an incremental lifecycle model, a waterfall lifecycle model, an iterative lifecycle model and an evolutionary lifecycle model.

In this way, different views of instances of different lifecycle models for corresponding processes can be achieved for the same breakdown structure defined as an arrangement of reusable method elements and breakdown elements. Moreover, changes in any one of the underlying descriptors for one type of reusable method element automatically translates to linked descriptors for other types of reusable method elements in the arrangement. Accordingly, it is not required to maintain separate data structures to support different corresponding views of different instances of different lifecycle models for different processes defined by the arrangement of the reusable method elements.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A methods management data processing system comprising a method management tool comprising program code enabled to manage multiple different instances of different lifecycle models corresponding to different processes described by a single breakdown centric process representation.

2. The system of claim 1, wherein the lifecycle models comprise at least two lifecycle models selected from the group consisting of an incremental lifecycle model, a waterfall lifecycle model, an iterative lifecycle model and an evolutionary lifecycle model.

3. The system of claim 1, wherein the single breakdown centric process representation comprises a breakdown structure encapsulating a set of generic attributes and associations, the generic attributes and associations supporting a definition of multiple different lifecycle model instances.

4. The system of claim 1, wherein each of the source method elements comprises one of a task, a role and a work product.

5. The system of claim 1, wherein the single breakdown structure architecture comprises a plurality of activities defined for a process wherein each of the activities comprises an aggregation of breakdown elements in a work breakdown structure.

6. A method for managing multiple different instances of different lifecycle models as processes described by a single breakdown centric process representation, the method comprising:
defining a plurality of different processes from a single breakdown structure architecture; and,
rendering different instances of different lifecycle models for the different processes using the single breakdown structure architecture.

7. The method of claim 6, wherein defining a single breakdown structure architecture for a process, comprises:
aggregating breakdown elements in a breakdown structure; and,
defining a plurality activities for the process with the aggregation of breakdown elements in the breakdown structure.

8. The method of claim 6, wherein rendering a plurality of different views for different instances of different lifecycle models for the single breakdown structure architecture comprises rendering for the single breakdown structure a plurality of different views selected from the group consisting of a iterative lifecycle model view, a waterfall lifecycle model view, an incremental lifecycle model view, and an evolutionary lifecycle model view.

9. A computer program product comprising a computer usable medium having computer usable program code for providing multiple views for breakdown centric process representations, the computer program product including:
computer usable program code for defining a plurality of different processes from a single breakdown structure architecture; and,
computer usable program code for rendering different instances of different lifecycle models for the different processes using the single breakdown structure architecture.

10. The computer program product of claim 9, wherein the computer usable program code for defining a single breakdown structure architecture for a process, comprises:
computer usable program code for aggregating breakdown elements in a breakdown structure; and,
computer usable program code for defining a plurality activities for the process with the aggregation of breakdown elements in the breakdown structure.

11. The computer program product of claim 9, wherein the computer usable program code for rendering a plurality of different views for different instances of different lifecycle models for the single breakdown structure architecture comprises computer usable program code for rendering for the single breakdown structure a plurality of different views selected from the group consisting of a iterative lifecycle model view, a waterfall lifecycle model view, an incremental lifecycle model view, and an evolutionary lifecycle model view.
